(19) United States
(12) Patent Application Publication
(10) Pub. No.: US 2016/0132155 A1
(43) Pub. Date: May 12, 2016

(54) HIGH-SENSITIVITY MUTUAL-CAPACITANCE IN-CELL TOUCH DISPLAY PANEL DEVICE

(71) Applicant: SuperC-Touch Corporation, New Taipei City (TW)

(72) Inventors: Hsiang-Yu LEE, New Taipei City (TW); Shang CHIN, New Taipei City (TW); Ping-Tsun LIN, New Taipei City (TW)

(21) Appl. No.: 14/932,598

(22) Filed: Nov. 4, 2015

(30) Foreign Application Priority Data
Nov. 7, 2014 (TW) 103138725

(51) Int. Cl. G06F 3/044; G02F 1/1333

(52) U.S. Cl. CPC G06F 3/044; G02F 1/13338; G06F 2203/04103

(57) ABSTRACT

A high-sensitivity mutual-capacitance in-cell touch display panel device includes plural receiving sensing electrodes, a display control circuit, a touch sensing control circuit, and a touch signal driving circuit. The display control circuit is powered by a first power source and connected to a first ground. The touch sensing control circuit is coupled to the plural receiving sensing electrodes. The touch sensing control circuit is powered by a second power source and connected to a second ground, wherein the first power source and the first ground are different from the second power source and the second ground. The touch signal driving circuit is connected to the touch sensing control circuit and a common voltage layer. The touch sensing control circuit applies a touch signal to the touch signal driving circuit to generate a transmitting signal for being applied to the common voltage layer.

### BACKGROUND OF THE INVENTION

1. Field of the Invention

The present invention relates to the technical field of touch panels and, more particularly, to a high-sensitivity mutual-capacitance in-cell touch display panel device.

2. Description of Related Art

The conventional touch display panel includes a touch panel and a display unit overlapped with the touch panel. The touch panel is configured as an operation interface. The touch panel is transparent so that an image generated by the display unit can be viewed directly by a user without being sheltered by the touch panel. Such well known skill of the touch panel may increase additional weight and thickness of the touch display panel, and may further reduce the light penetration rate, and increase reflectance and haze of the touch display panel.

On-cell and in-cell touch technology were invented to overcome the drawbacks of traditional touch technology described above. The on-cell technology is to dispose a sensor on the back side of a color filter substrate to form a completed color filter substrate. One of the on-cell touch technologies is provided to dispose a touch sensor on a thin film and then bond the thin film onto the upper one of the two substrates. The in-cell technology is to dispose the sensor within the LCD cell structure. However, when the sensor is disposed within the LCD cell structure, the distance between the sensor and the common voltage layer is only several micrometers and thus the capacitance induced therebetween is greatly increased, such that, in comparison with such a large capacitance, the capacitance change caused by touch is too small to be detected. Furthermore, because of the short distance, the display signal may be seriously interfered, resulting in a bad display quality.

FIG. 1 schematically illustrates the transparent electrode structure of a single-layer touch panel. As shown, there is a plurality of transparent electrodes 11 arranged in rows and columns, and the electrical signal sensed by one transparent electrode 11 is transmitted through a corresponding conductive wire 12 for output. Such a single-layer transparent electrode structure can realize an actual multi-touch detection. In use, the single-layer transparent electrode structure of FIG. 1 is combined with a display panel. However, when the single-layer transparent electrode structure is integrated to the inside of a display panel, there will be an obvious capacitance produced between the single-layer transparent electrode structure and a common voltage layer of the display panel, which may cause noises to be produced and thus lower the accuracy in detection the touch position. In order to solve the aforementioned problems for the in-cell touch panel, a direct solution is to partition the common voltage layer into several blocks for being operated with the display control in a time sharing manner, which not only restricts the resolution and size of the touch screen but also negatively influences the display quality and greatly increases the difficulties in designing and trimming of the display control circuit and manufacture of the panel, resulting in low production yield and high manufacturing cost. Therefore, it desired for the aforementioned in-cell touch display panel structure to be improved.

### SUMMARY OF THE INVENTION

The object of the present invention is to provide a high-sensitivity mutual-capacitance in-cell touch display panel device, with which there is no need to partition the common voltage layer for being operated with the display control in a time sharing manner. Therefore, the size and the resolution of the touch panel are no longer restricted while the display quality is also not interfered.

In one aspect of the present invention, there is provided a high-sensitivity mutual-capacitance in-cell touch display panel device, which comprises: a first substrate; a second substrate parallel to the first substrate; a display material layer configured between the first substrate and the second substrate; a common voltage layer disposed between the first substrate and the display material layer; a plurality of receiving sensing electrodes disposed between the first substrate and the common voltage layer; a display control circuit for controlling the high-sensitivity mutual-capacitance in-cell touch display panel device to display image, wherein the display control circuit is powered by a first power source and is connected to a first ground; a touch sensing control circuit coupled to the plurality of receiving sensing electrodes for receiving a touch sensing signal sensed by each receiving sensing electrode, wherein the touch sensing control circuit is powered by a second power source and is connected to a second ground; and a touch signal driving circuit connected to the touch sensing control circuit and the common voltage layer, wherein the first power source and the first ground are different from the second power source and the second ground and, in touch sensing detection, the touch sensing control circuit applies a touch signal to the touch signal driving circuit to generate a transmitting signal for being applied to the common voltage layer, and the plurality of receiving sensing electrodes receive the touch sensing signals.

In another aspect of the present invention, there is provided a high-sensitivity mutual-capacitance in-cell touch display panel device, which comprises: a first substrate; a common voltage layer; a second substrate parallel to the first substrate; a display material layer configured between the first substrate and the second substrate; a plurality of receiving sensing electrodes, each formed by metal mesh; a display control circuit for controlling the high-sensitivity mutual-capacitance in-cell touch display panel device to display image, wherein the display control circuit is powered by a first power source and is connected to a first ground; a touch sensing control circuit coupled to the plurality of receiving sensing electrodes for receiving a touch sensing signal sensed by each receiving sensing electrode, wherein the touch sensing control circuit is powered by a second power source and is connected to a second ground; and a touch signal driving circuit connected to the touch sensing control circuit and the common voltage layer, wherein the first power source and the first ground are different from the second power source and the second ground and, in touch sensing detection, the touch sensing control circuit applies a touch signal to the touch signal driving circuit to generate a transmitting signal for being applied to the common voltage layer, and the plurality of receiving sensing electrodes receive the touch sensing signals.

In still another aspect of the present invention, there is provided a high-sensitivity mutual-capacitance in-cell touch display panel device, which comprises: a first substrate; a second substrate parallel to the first substrate; a display material layer configured between the first substrate and the second substrate; a cathode layer disposed at one side of the first substrate facing the display material; a plurality of receiving sensing electrodes disposed between the first substrate and the second substrate; a display control circuit for controlling the high-sensitivity mutual-capacitance in-cell touch display panel device to display image, wherein the display control circuit is powered by a first power source and is connected to a first ground; a touch sensing control circuit coupled to the plurality of receiving sensing electrodes for receiving a touch sensing signal sensed by each receiving sensing electrode, wherein the touch sensing control circuit is powered by a second power source and is connected to a second ground; and a touch signal driving circuit connected to the touch sensing control circuit and the cathode layer, wherein the first power source and the first ground are different from the second power source and the second ground and, in touch sensing detection, the touch sensing control circuit applies a touch signal to the touch signal driving circuit to generate a transmitting signal for being applied to the cathode layer, and the plurality of receiving sensing electrodes receives the touch sensing signals.

In yet another aspect of the present invention, there is provided a high-sensitivity mutual-capacitance in-cell touch display panel device, which comprises: a first substrate; a second substrate parallel to the first substrate; a display material layer configured between the first substrate and the second substrate; an anode layer disposed at one side of the first substrate facing the display material layer; a plurality of receiving sensing electrodes disposed between the first substrate and the second substrate; a display control circuit for controlling the high-sensitivity mutual-capacitance in-cell touch display panel device to display image, wherein the display control circuit is powered by a first power source and is connected to a first ground; a touch sensing control circuit coupled to the plurality of receiving sensing electrodes for receiving a touch sensing signal sensed by each receiving sensing electrode, wherein the touch sensing control circuit is powered by a second power source and is connected to a second ground; and a touch signal driving circuit connected to the touch sensing control circuit and the anode layer, wherein the first power source and the first ground are different from the second power source and the second ground and, in touch sensing detection, the touch sensing control circuit applies a touch signal to the touch signal driving circuit to generate a transmitting signal for being applied to the anode layer, and the plurality of receiving sensing electrodes receives the touch sensing signals.

Other objects, advantages, and novel features of the invention will become more apparent from the following detailed description when taken in conjunction with the accompanying drawings.

### BRIEF DESCRIPTION OF THE DRAWINGS

FIG. 1 schematically illustrates a transparent electrode structure of a single-layer touch panel in the prior art;

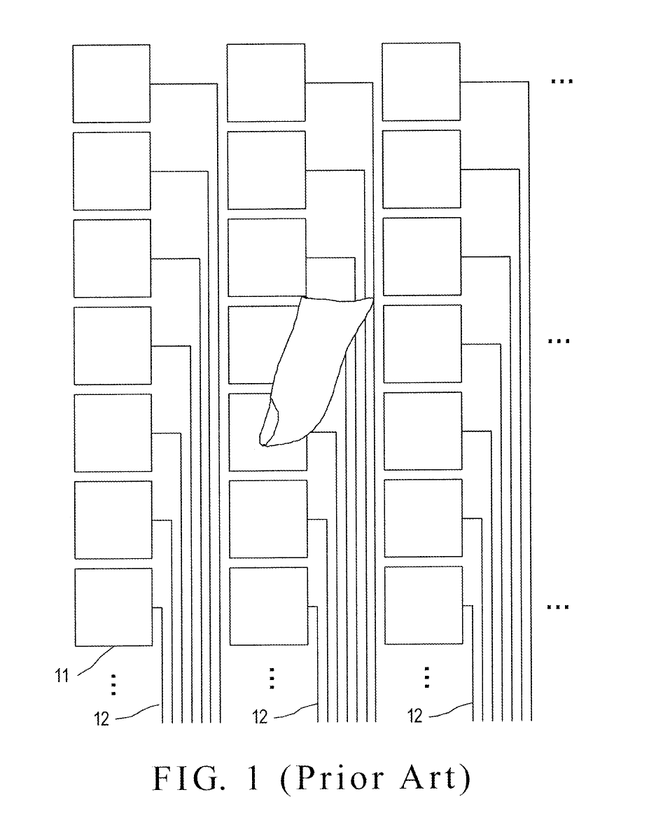

FIG. 2 shows a high-sensitivity mutual-capacitance in-cell touch display panel device in accordance with one embodiment of the present invention;

FIG. 3 shows the black matrix layer in accordance with the present invention;

FIG. 4 is a schematic view of the sensing reception electrode layer in accordance with the present invention;

FIG. 5 schematically illustrates the operation principle of the high-sensitivity mutual-capacitance in-cell touch display panel device in accordance with the present invention;

FIG. 6 is a schematic view of the high-sensitivity mutual-capacitance in-cell touch display panel device in accordance with the present invention;

FIG. 7 is a stacked diagram of the high-sensitivity mutual-capacitance in-cell touch display panel device in accordance with another embodiment of the present invention;

FIG. 8 is a stacked diagram of the high-sensitivity mutual-capacitance in-cell touch display panel device in accordance with still another embodiment of the present invention;

FIG. 9 is a stacked diagram of the high-sensitivity mutual-capacitance in-cell touch display panel device in accordance with yet another embodiment of the present invention;

FIG. 10 is a stacked diagram of the high-sensitivity mutual-capacitance in-cell touch display panel device in accordance with further another embodiment of the present invention; and

FIG. 11 is a stacked diagram of the high-sensitivity mutual-capacitance in-cell touch display panel device in accordance with still further another embodiment of the present invention.

### DETAILED DESCRIPTION OF THE PREFERRED EMBODIMENT

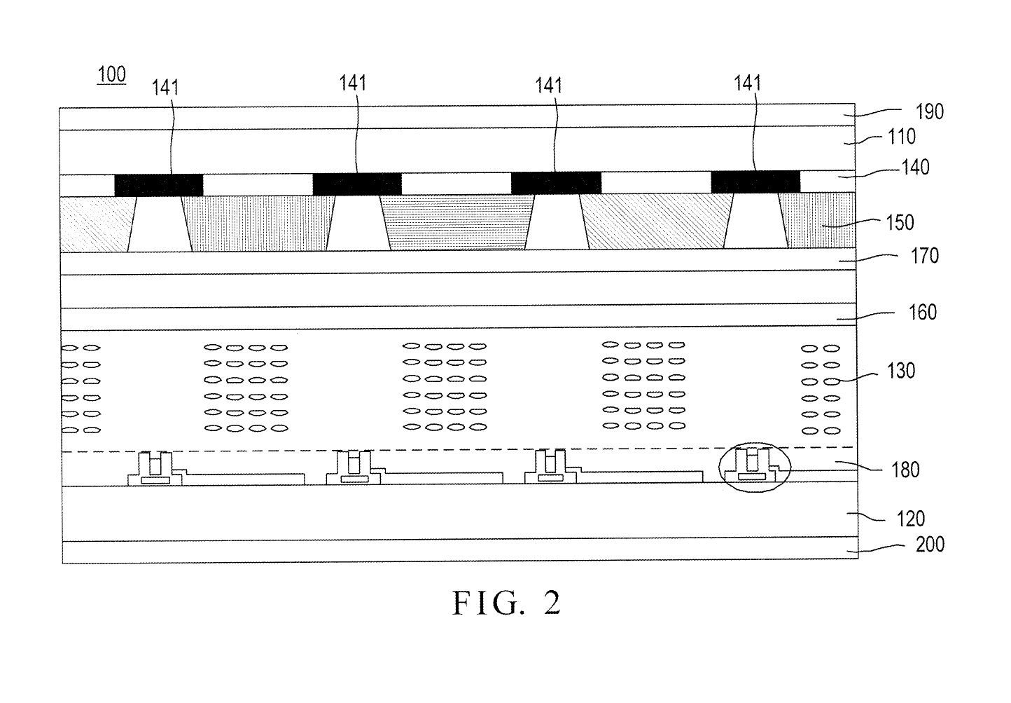

With reference to FIG. 2, there is shown a high-sensitivity mutual-capacitance in-cell touch display panel device in accordance with one embodiment of the present invention. As shown, the high-sensitivity mutual-capacitance in-cell touch display panel device 100 includes a first substrate 110, a second substrate 120, a display material layer 130, a black matrix layer 140, a color filter layer 150, a common voltage (Vcom) layer 160, a sensing reception electrode layer 170, a thin film transistor layer 180, a first polarizer layer 190, and a second polarizer layer 200.

The first substrate 110 and the second substrate 120 are preferably glass substrates, and are parallel to each other. The display material layer 130 is disposed between the first and second substrates 110, 120. In this embodiment, the display material layer 130 is preferably a liquid crystal material layer.

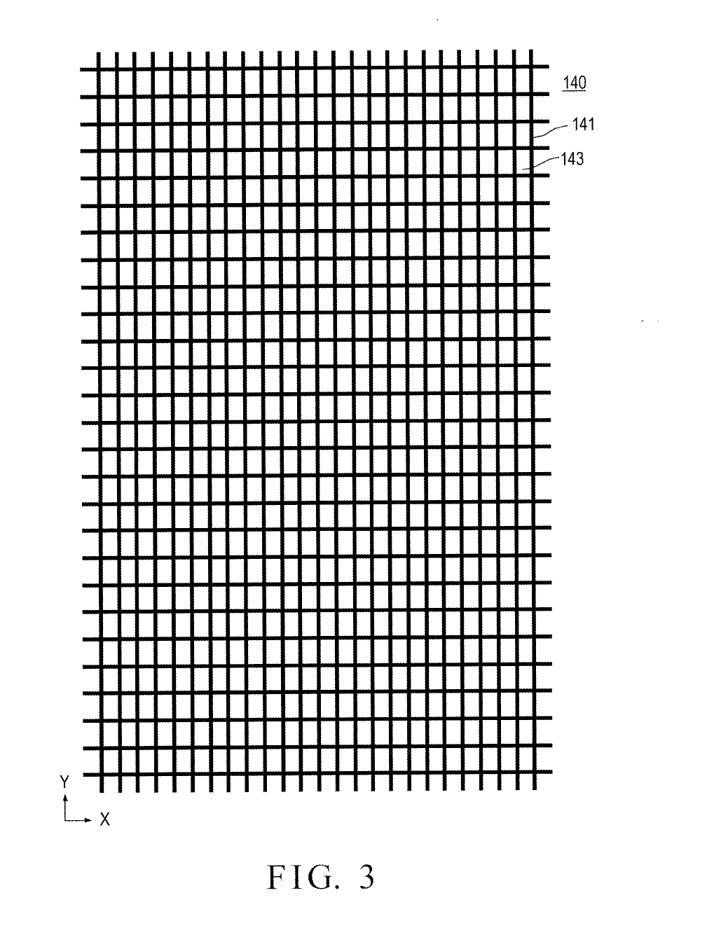

The black matrix layer 140 is between the first substrate 110 and the display material layer 130 and is disposed at one side of the first substrate 110 that faces the display material layer 130. As shown in FIG. 3, the black matrix layer 140 is composed of a plurality of opaque lines 141 arranged in a first direction (X-axis direction) and a second direction (Y-axis direction) for defining a plurality of light-penetrating blocks 143, wherein the first direction is substantially perpendicular to the second direction.

FIG. 3 schematically illustrates the black matrix layer 140, which is the same as that of the prior LCD panel. As shown, the black matrix layer 140 is composed of a plurality of opaque lines 141 of insulating material that are black and opaque. The plurality of lines 141 of black insulating material is arranged as a checkerboard pattern in which the plurality of light-penetrating blocks 143 is defined. The plurality of opaque lines 141 is disposed at positions corresponding to those of gate lines and source lines of the thin film transistor layer 180, wherein the gate lines and source lines are well-known to those skilled in the art of LCD device and thus are not drawn in the figures.

The common voltage layer 160 is disposed between the first substrate 110 and the display material layer 130. The common voltage layer 160 can be a direct current common voltage (DC Vcom) layer or alternating current common voltage (AC Vcom) layer.

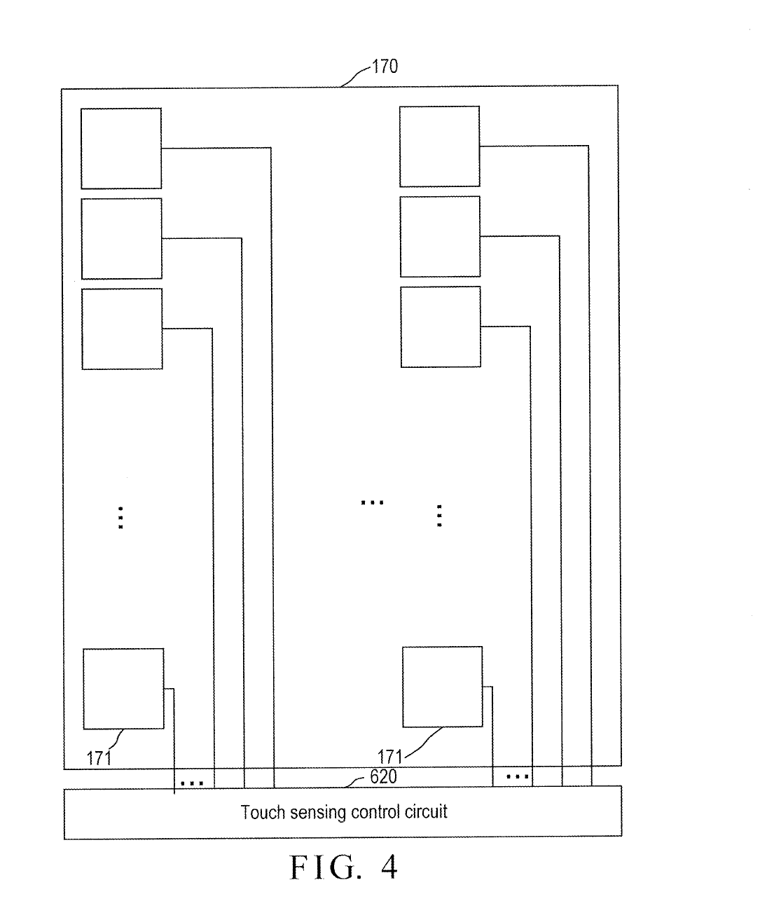

FIG. 4 is a schematic view of the sensing reception electrode layer in accordance with the present invention. The sensing reception electrode layer 170 is disposed between the first substrate 110 and the common voltage layer 160. The sensing reception electrode layer 170 includes a plurality of receiving sensing electrodes 171. The plurality of receiving sensing electrodes 171 is connected to a touch sensing control circuit 620.

Each of the receiving sensing electrodes 171 can be a polygon, circle, ellipse, star, wedge shape, radiation shape, triangle, pentagon, hexagon, octagon, rectangle, or square. Each receiving sensing electrode 171 is made of material selected from the group consisting of: indium tin oxide (ITO), zinc tin oxide thin film, ETO, nano silver, conductive polymer, carbon nanotube, and graphene.

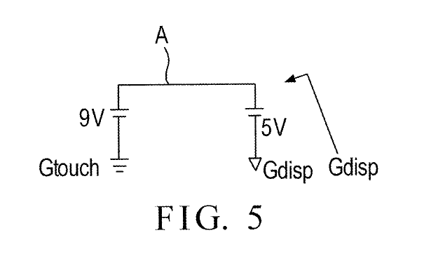

FIG. 5 schematically illustrates the operation principle of the high-sensitivity mutual-capacitance in-cell touch display panel device 100 in accordance with the present invention, wherein the grounding of the 5V DC voltage is a first ground (Gdisp) and the grounding of the 9V DC voltage is a second ground (Gtouch). Because the grounding of the 9V DC voltage is the second ground (Gtouch), only 5V can be measured between a node A and the first ground (Gdisp). That is, the 9V DC voltage has no influence to the first ground (Gdisp). Similarly, because the grounding of the 5V DC voltage is the first ground (Gdisp), only 9V can be measured between the node A and the second ground (Gtouch). That is, the 5V DC voltage has no influence to the second ground (Gtouch).

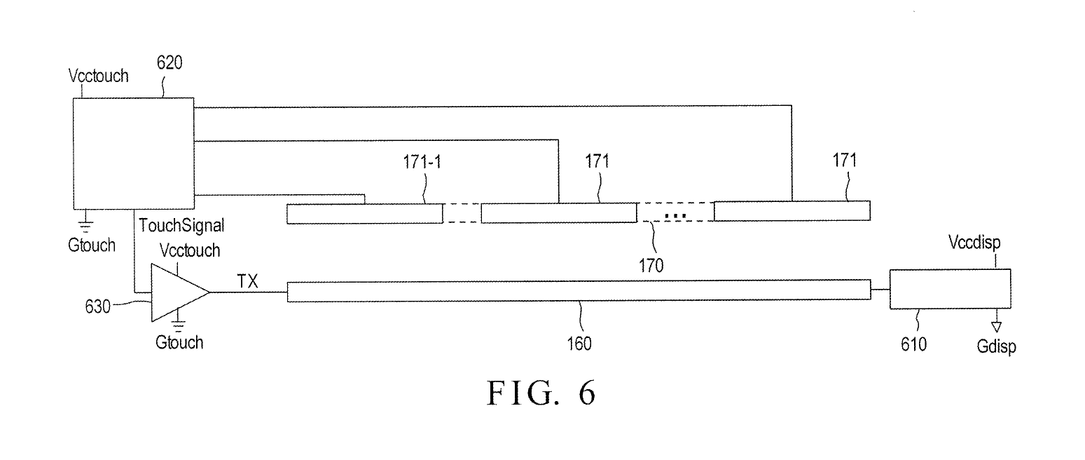

FIG. 6 is a schematic view of the high-sensitivity mutual-capacitance in-cell touch display panel device 100 in accordance with the present invention. As shown, a display control circuit 610 is provided to control the display operation of the mutual-capacitance in-cell touch display panel device 100. The display control circuit 610 is powered by a first power source (Vccdisp) and is connected to the first ground (Gdisp). The display control circuit 610 is connected to the common voltage (Vcom) layer 160. If the common voltage layer 160 is a DC Vcom layer, the display control circuit 610 electrically connects the first ground (Gdisp) to the common voltage layer 160. If the common voltage layer 160 is an AC Vcom layer, the display control circuit 610 outputs an AC signal based on the first ground (Gdisp) to the common voltage layer 160.

With reference to both FIG. 4 and FIG. 6, the touch sensing control circuit 620 is connected to the plurality of receiving sensing electrodes 171 for receiving touch sensing signal sensed by each receiving sensing electrode 171 during a touch sensing operation. The touch sensing control circuit 620 is powered by a second power source (Vcctouch) and is connected to the second ground (Gtouch). The first power source (Vccdisp) and the first ground (Gdisp) are different from the second power source (Vcctouch) and the second ground (Gtouch); i.e., there is no common current loop therebetween.

A touch signal driving circuit 630 is connected to the touch sensing control circuit 620 and the common voltage layer 160. The touch signal driving circuit 630 is powered by the second power source (Vcctouch) and is connected to the second ground (Gtouch). In performing a touching sensing detection, the touch sensing control circuit 620 applies a touch signal (TouchSignal) to the touch signal driving circuit 630 to generate a transmitting signal (TX) for being applied to the common voltage layer 160. Therefore, the common voltage layer 160 also serves as a touch transmitting electrode, and the plurality of receiving sensing electrodes 171 is used to receive the touch sensing signal.

With reference to FIG. 2 again, the color filter layer 150 is disposed at one side of the black matrix layer 140 that faces the display material layer 130.

The thin film transistor layer 180 is disposed at one side of the second substrate 120 that faces the display material layer 130, and includes K gate lines and L source lines, wherein K, L are each a positive integer, and the gates lines and source lines are well-known to those skilled in the typical LCD device and thus are not shown in the figure. The K gate lines are arranged in the first direction, and the L source lines are arranged in the second direction, so as to form a plurality of pixel blocks. Each pixel block has a pixel transistor and a capacitor corresponding thereto, so as to drive the corresponding pixel transistor and capacitor according to a display pixel signal and a display driving signal thereby performing a display operation. The plurality of opaque lines 141 is disposed at positions corresponding to those of the K gate lines and L source lines.

The first polarizer layer 190 is disposed at one side the first substrate 110 opposite to the other side of the first substrate 110 facing the display material layer 130. The second polarizer layer 200 is disposed at one side of the second substrate 120 opposite to the other side of the second substrate 120 facing the display material layer 130.

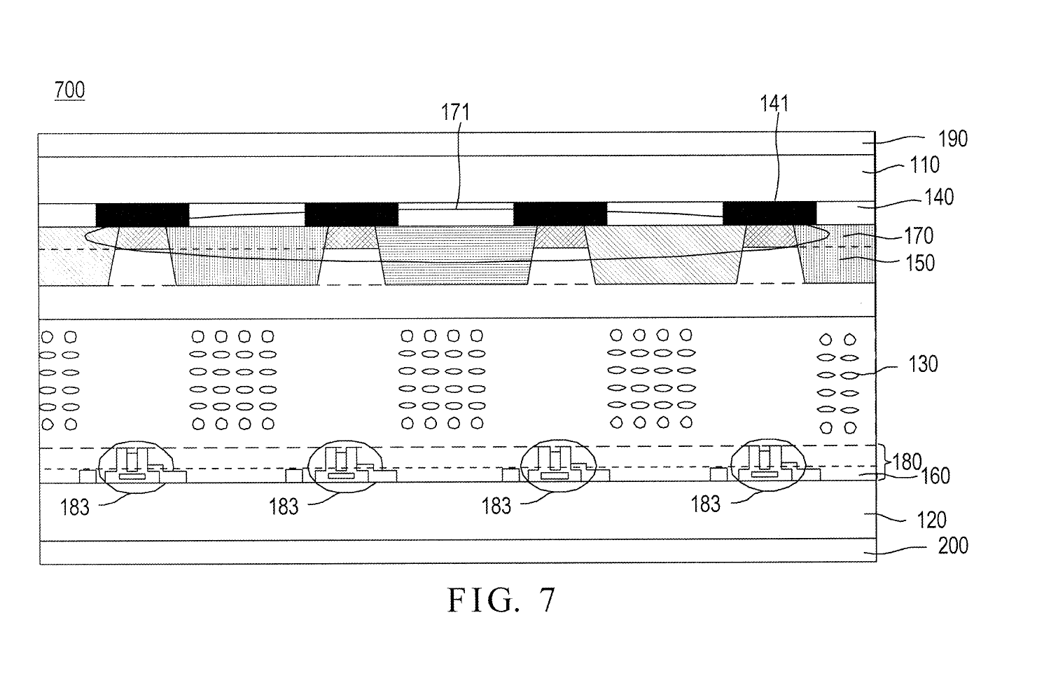

FIG. 7 is a stacked diagram of the high-sensitivity mutual-capacitance in-cell touch display panel device 700 in accordance with another embodiment of the present invention. As shown, the high-sensitivity mutual-capacitance in-cell touch display panel device 700 includes a first substrate 110, a second substrate 120, a display material layer 130, a black matrix layer 140, a color filter layer 150, a sensing reception electrode layer 170, a thin film transistor layer 180, a first polarizer layer 190, and a second polarizer layer 200. This embodiment is similar to that of FIG. 2 except that: the sensing reception electrode layer 170 is disposed at one side of the black matrix layer 140 facing the display material layer 130 and the sensing reception electrode layer 170 includes a plurality of receiving sensing electrodes 171, each receiving sensing electrode 171 being formed by metal mesh. That is, the plurality of receiving sensing electrodes 171 is disposed at one side of the black matrix layer 140 facing the display material layer 130, and the common voltage layer 160 is disposed in the thin film transistor layer 180. The material of the metal mash is selected from the group consisting of chromium, barium, molybdenum, aluminum, silver, copper, titanium, nickel, tantalum, cobalt, tungsten, magnesium (Mg), calcium (Ca), potassium (K), lithium (Li), indium (In), an alloy thereof, fluorine lithium (LiF), magnesium fluoride (MgF₂), and lithium oxide (Li₂O).

The technique for the receiving sensing electrode 171 formed by metal mesh has been described in detail in US patent Publication No. 20150009426, 20150049264, 2050085208, 20140192275, 20130314371, 20140375911, 20130314371, 20140346493, 20140353691 and 20140326967 filed by the same applicant. The common voltage layer 160 being disposed in the thin film transistor layer 180 indicates that the panel is an IPS type LCD panel.

The black matrix layer 140 is between the first substrate 110 and the display material layer 130 and is disposed at one side of the first substrate 110 that faces the display material layer 130. The black matrix layer 140 is composed of a plurality of opaque lines 141 arranged in a first direction and a second direction for defining a plurality of light-penetrating blocks.

The color filter layer 150 is disposed at one side of the black matrix layer 140 that faces the display material layer 130. The first polarizer layer 190 is disposed at one side the first substrate 110 opposite to the other side of the first substrate 110 facing the display material layer 130. The thin film transistor layer 180 is disposed at one side of the second substrate 120 that faces the display material layer 130, and includes K gate lines and L source lines, wherein K, L are each a positive integer, and the gates lines and source lines are well-known to those skilled in the typical LCD device and thus are not shown in the figure. The K gate lines are arranged in the first direction, and the L source lines are arranged in the second direction, so as to form a plurality of pixel blocks. Each pixel block has a pixel transistor and a capacitor corresponding thereto, so as to drive the corresponding pixel transistor and capacitor according to a display pixel signal and a display driving signal thereby performing a display operation. The second polarizer layer 200 is disposed at one side of the second substrate 120 opposite to the other side of the second substrate 120 facing the display material layer 130.

The plurality of opaque lines 141 is disposed at positions corresponding to those of the K gate lines and L source lines. The sensing electrodes formed by metal mesh are disposed at positions corresponding to those of the plurality of opaque lines 141.

In other embodiments, the sensing reception electrode layer 170 is disposed in the thin film transistor layer 180; i.e., the plurality of receiving sensing electrodes is disposed in the thin film transistor layer 180. The technique for forming metal mesh type sensing electrodes in the thin film transistor layer 180 or forming metal mesh type sensing electrodes on the first substrate 110 has been described in detail in US patent Publication No. 20150049264, 20150085208, 20140192275, 20130314371, 20140375911, 20130314371, 20140346493, 20140353691 and 20140326967 filed by the same applicant.

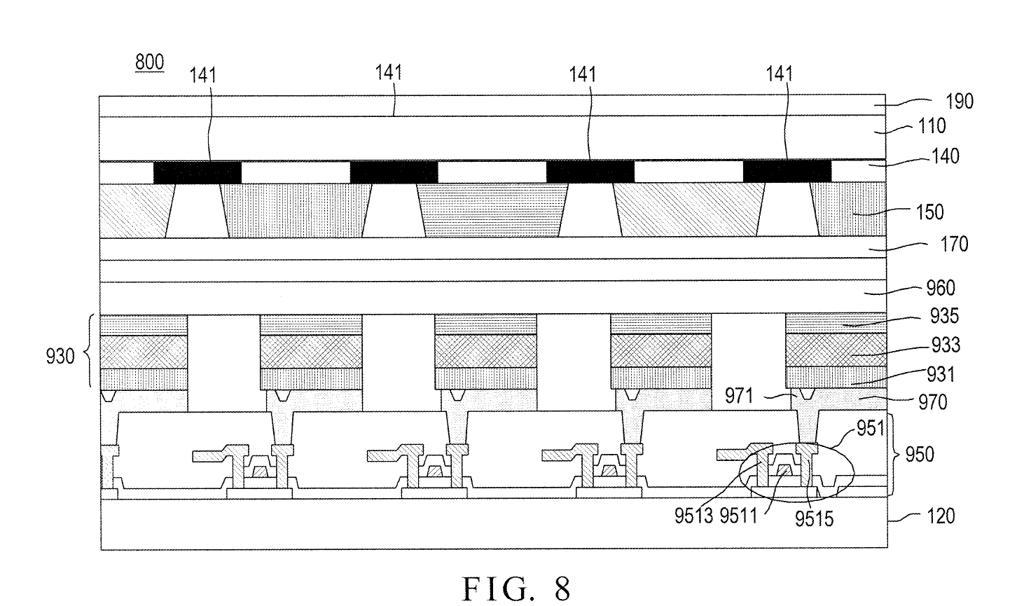

FIG. 8 is a stacked diagram of the high-sensitivity mutual-capacitance in-cell touch display panel device 800 in accordance with still another embodiment of the present invention. As shown, the high-sensitivity mutual-capacitance in-cell touch display panel device 800 is similar to those of FIG. 2 and FIG. 6 except for the display material layer 930, the cathode layer 960, the anode layer 970 and the thin film transistor layer 950, and the output of the touch signal driving circuit 630 being connected to the cathode layer 960. In performing a touch sensing detection, the touch sensing control circuit 620 applies a touch signal to the touch signal driving circuit 630 to generate a transmitting signal (TX) for being applied to the cathode 960. Therefore, the cathode layer 960 also serves as a touch transmitting electrode, and the plurality of receiving sensing electrodes 171 is used to receive the touch sensing signal. In this embodiment, the display material layer 930 is an organic light emitting diode layer.

The cathode layer 960 is disposed at one side of the first substrate 110 facing the display material layer 930 and between the first substrate 110 and the display material layer 930. The cathode layer 960 is made of metal material, preferably metal material with thickness being less than 50 nm. The metal material is selected from the group consisting of: chromium, barium, nickel, molybdenum, aluminum (Al), silver (Ag), copper, magnesium (Mg), calcium (Ca), tantalum, cobalt, tungsten, potassium (K), lithium (Li), indium (In), alloy thereof, or mixture of lithium fluoride (LiF), magnesium fluoride (MgF₂), lithium oxide (Li₂O) and aluminum. Due to the thickness of the cathode layer 960 being less than 50 nm, the light generated by the display material layer 930 can pass through the cathode layer 960, so as to show images on the first substrate 110. The cathode layer 960 is electrically connected in the whole piece. The cathode layer 960 receives the current coming from the anode pixel electrode 971.

The color filter layer 150 is disposed at one side of the black matrix layer 140 that faces the display material layer 130.

The thin film transistor layer 950 is disposed at one side of the second substrate 120 that faces the display material layer 930, and includes a plurality of gate lines (not shown), a plurality of source lines (not shown), and a plurality pixel driving circuits 951. Each pixel driving circuit 951 is corresponding to a pixel, so as to drive the corresponding pixel driving circuit 951 according to a display pixel signal and a display driving signal thereby performing a display operation. The plurality of gate lines and the plurality of source lines define a plurality of pixel areas, each corresponding to a light penetrating block 143.

According to different designs of driving circuit 951 (such as 2T1C is formed with two thin film transistors and a storage capacitor, and 6T2C is formed with six thin film transistors and two storage capacitors), a gate 9511 of at least one thin film transistor in the pixel driving circuit 951 is connected to a gate line (not shown). According to different designs of driving circuit, a source/drain 9513 of at least one thin film transistor in the control circuit is connected to a source line (not shown) and a source/drain 9515 of at least one thin film transistor in pixel driving circuit 951 is connected to a corresponding anode pixel electrode 971 of the anode layer 970.

The anode layer 970 is disposed at one side of the thin film transistor layer 950 facing the display material layer 930 and includes a plurality of anode pixel electrodes 971. Each of the anode pixel electrodes 971 is corresponding to one of the pixel driving transistors 951 of the thin film transistor layer 950. That is, each of the anode pixel electrodes is connected to a source/drain of the corresponding pixel driving transistor 951, so as to form a pixel electrode of a specific color, for example a red pixel electrode, a green pixel electrode, or a blue pixel electrode.

The display material layer 930 includes a hole transporting layer 931, an emitting layer 933, and an electron transporting layer 935. The display material layer 930 preferably generates white light, which is filtered to generate three primary colors of red, blue and green by using the color filter 150.

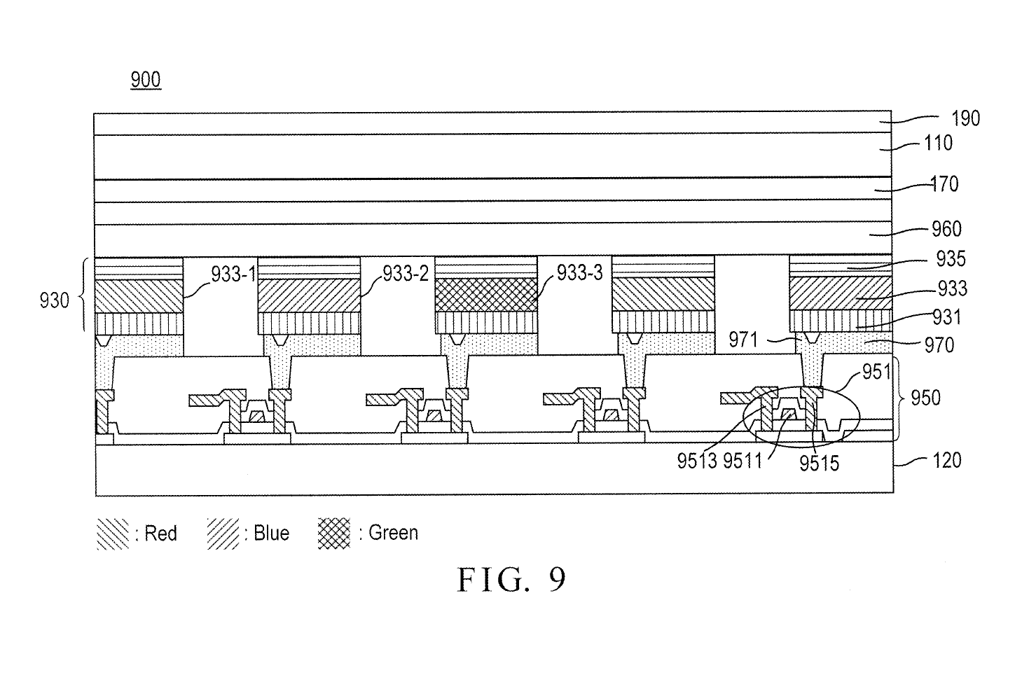

FIG. 9 is a stacked diagram of the high-sensitivity mutual-capacitance in-cell touch display panel device 900 in accordance with yet another embodiment of the present invention. As shown, the high-sensitivity mutual-capacitance in-cell touch display panel device 900 is similar to that of FIG. 8 except that: a red emitting layer 933-1, a blue emitting layer 933-2 and a green emitting layer 933-3 are provided in FIG. 9 so that there is no need to use a color filter layer and a black matrix layer.

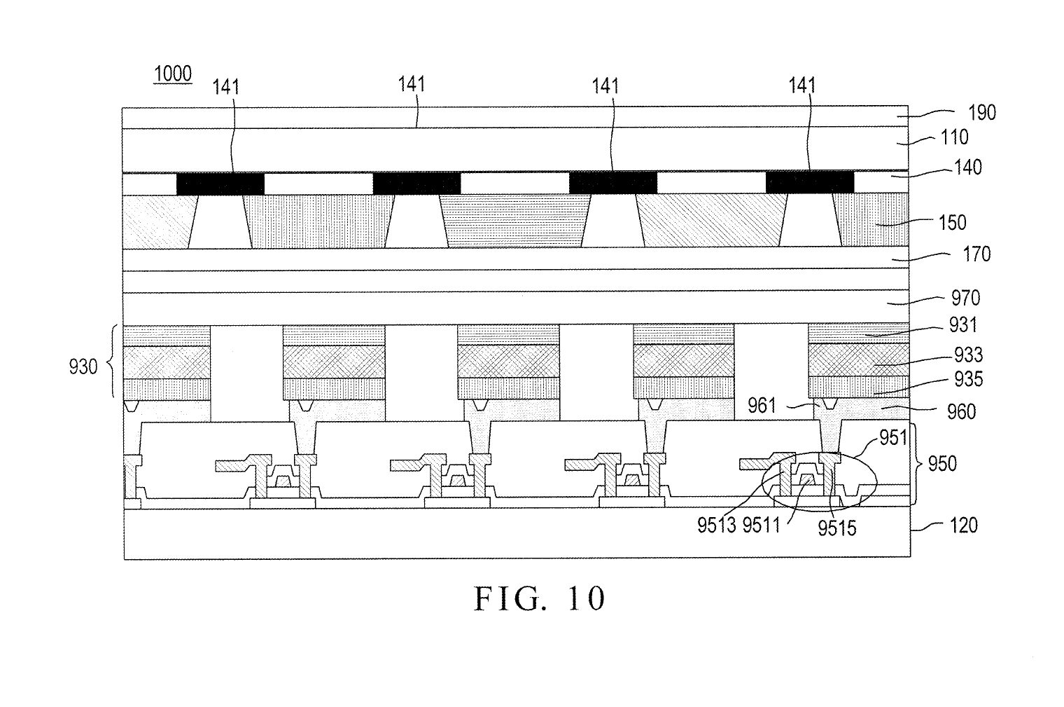

FIG. 10 is a stacked diagram of the high-sensitivity mutual-capacitance in-cell touch display panel device 1000 in accordance with further another embodiment of the present invention. As shown, the high-sensitivity mutual-capacitance in-cell touch display panel device 1000 is similar to that of FIG. 8 except that the positions of the cathode layer 960 and the anode layer 970 are exchanged with each other. The cathode layer 960 includes a plurality of cathode pixel electrodes 961, each corresponding to one pixel driving transistor of the pixel driving circuit 951 of the thin film transistor layer 950. That is, each of the cathode pixel electrodes is connected to a source/drain 9515 of the pixel driving transistor of the corresponding pixel driving circuit 951, so as to form a pixel electrode of a specific color, for example a red pixel electrode, a green pixel electrode, or a blue pixel electrode.

In FIG. 10, corresponding to the exchange of the positions of the cathode layer 960 and the anode layer 970, the positions of the hole transporting layer 931 and the electron transporting layer 935 of the display material layer 930 are also exchanged with each other. The cathode layer 960 includes a plurality of cathode pixel electrodes 961. Each of the cathode pixel electrodes 961 is connected to a source/drain of the pixel driving transistor of the corresponding pixel driving circuit.

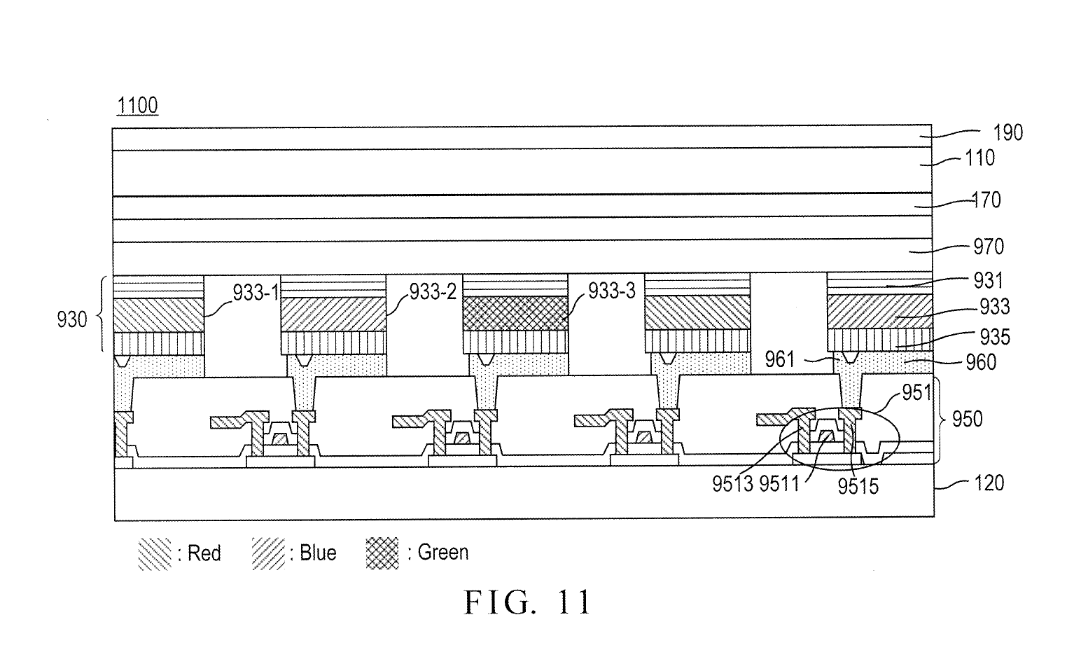

In this embodiment, the output of the touch signal driving circuit 630 is connected to the anode layer 970. In performing a touch sensing detection, the touch sensing control circuit applies a touch signal to the touch signal driving circuit 630 to generate a transmitting signal (TX) for being applied to the anode 970. Therefore, the anode layer 970 also serves as a touch transmitting electrode, and the plurality of receiving sensing electrodes 171 is used to receive the touch signals. In this embodiment, the display material layer 930 is an organic light emitting diode layer. FIG. 11 is a stacked diagram of the high-sensitivity mutual-capacitance in-cell touch display panel device 1100 in accordance with still further another embodiment of the present invention. As shown, the high-sensitivity mutual-capacitance in-cell touch display panel device 1100 is similar to that of FIG. 10 except that: a red emitting layer 933-1, a blue emitting layer 933-2 and a green emitting layer 933-3 are provided in FIG. 10 so that there is no need to use a color filter layer and a black matrix layer.

In view of the foregoing, it is known that, in the present invention, the common voltage layer, the cathode layer or the anode layer may also serve as a transmitting electrode (TX electrode) in the mutual-capacitance sensing technology. When performing a touch sensing detection, the common voltage layer, the cathode layer or the anode layer is provided with a touch driving transmitting signal (TX signal), which is coupled to the plurality of receiving sensing electrodes 171 through the mutual capacitance (Cm) between the common voltage layer, the cathode layer or the anode layer and the plurality of receiving sensing electrodes 171. By measuring the plurality of receiving sensing electrodes 171, the touch sensing control circuit 620 obtains the touch sensing signals. Therefore, with the present invention, there is no need to partition the common voltage layer for being operated with the display control in a time sharing manner, so that the size and the resolution of the touch panel are no longer restricted. Furthermore, in order to prevent the display panel from being interfered by the touch transmitting signal (TX) applied to the common voltage layer 160, the power source and the ground for the display control circuit 610 are different from those for the touch sensing control circuit 620 and the touch signal driving circuit 630, so as not to interfere the display quality.

Although the present invention has been explained in relation to its preferred embodiment, it is to be understood that many other possible modifications and variations can be made without departing from the spirit and scope of the invention as hereinafter claimed.

What is claimed is:

1. A high-sensitivity mutual-capacitance in-cell touch display panel device, comprising:
a first substrate;
a second substrate parallel to the first substrate;
a display material layer configured between the first substrate and the second substrate;
a common voltage layer disposed between the first substrate and the display material layer;
a plurality of receiving sensing electrodes disposed between the first substrate and the common voltage layer;
a display control circuit for controlling the high-sensitivity mutual-capacitance in-cell touch display panel device to display image, wherein the display control circuit is powered by a first power source and is connected to a first ground;
a touch sensing control circuit coupled to the plurality of receiving sensing electrodes for receiving a touch sensing signal sensed by each receiving sensing electrode, wherein the touch sensing control circuit is powered by a second power source and is connected to a second ground; and
a touch signal driving circuit connected to the touch sensing control circuit and the common voltage layer,
wherein the first power source and the first ground are different from the second power source and the second ground and, in touch sensing detection, the touch sensing control circuit applies a touch signal to the touch signal driving circuit to generate a transmitting signal for being applied to the common voltage layer, and the plurality of receiving sensing electrodes receives the touch sensing signals.

2. The high-sensitivity mutual-capacitance in-cell touch display panel device as claimed in claim 1, further comprising:
a black matrix layer disposed at one side of the first substrate facing the display material layer, the black matrix layer being composed of a plurality of opaque lines arranged in a first direction and a second direction thereby defining a plurality of light-penetrating blocks, wherein the first direction is perpendicular to the second direction;
a color filter layer disposed at one side of black matrix layer facing the display material layer;
a first polarizer layer disposed at one side the first substrate opposite to the other side of the first substrate facing the display material layer;
a thin film transistor layer disposed at the side of the second substrate facing the display material layer, and including K gate lines and L source lines, where K and L are each a positive integer, the K gate lines being arranged in the first direction and the L source lines being arranged in the second direction for forming a plurality of pixel blocks, each pixel block having a pixel transistor and a capacitor corresponding thereto, so as to drive the corresponding pixel transistor and capacitor according to a display pixel signal and a display driving signal thereby performing a display operation; and
a second polarizer layer disposed at one side of the second substrate opposite to the other side of the second substrate facing the display material layer,
wherein the plurality of opaque lines are disposed at positions corresponding to those of the K gate lines and L source lines.

3. The high-sensitivity mutual-capacitance in-cell touch display panel device as claimed in claim 2, wherein each of the receiving sensing electrodes is a polygon, circle, ellipse, star, wedge shape, radiation shape, triangle, pentagon, hexagon, octagon, rectangle, or square.

4. The high-sensitivity mutual-capacitance in-cell touch display panel device as claimed in claim 3, wherein each of the receiving sensing electrodes is made of material selected from the group consisting of indium tin oxide, zinc tin oxide thin film, ETO, nano silver, conductive polymer, carbon nanotube, and graphene.

5. A high-sensitivity mutual-capacitance in-cell touch display panel device, comprising:
a first substrate;
a common voltage layer;
a second substrate parallel to the first substrate;
a display material layer configured between the first substrate and the second substrate;
a plurality of receiving sensing electrodes, each formed by metal mesh;
a display control circuit for controlling the high-sensitivity mutual-capacitance in-cell touch display panel device to display image, wherein the display control circuit is powered by a first power source and is connected to a first ground;
a touch sensing control circuit coupled to the plurality of receiving sensing electrodes for receiving a touch sensing signal sensed by each receiving sensing electrode, wherein the touch sensing control circuit is powered by a second power source and is connected to a second ground; and
a touch signal driving circuit connected to the touch sensing control circuit and the common voltage layer,
wherein the first power source and the first ground are different from the second power source and the second ground and, in touch sensing detection, the touch sensing control circuit applies a touch signal to the touch signal driving circuit to generate a transmitting signal for being applied to the common voltage layer, and the plurality of receiving sensing electrodes receives the touch sensing signals.

6. The high-sensitivity mutual-capacitance in-cell touch display panel device as claimed in claim 5, further comprising:
a black matrix layer disposed at one side of the first substrate facing the display material layer, the black matrix layer being composed of a plurality of opaque lines arranged in a first direction and a second direction thereby defining a plurality of light-penetrating blocks, wherein the first direction is perpendicular to the second direction;
a color filter layer disposed at one side of black matrix layer facing the display material layer;
a first polarizer layer disposed at one side the first substrate opposite to the other side of the first substrate facing the display material layer;
a thin film transistor layer disposed at the side of the second substrate facing the display material layer, and including K gate lines and L source lines, where K and L are each a positive integer, the K gate lines being arranged in the first direction and the L source lines being arranged in the second direction for forming a plurality of pixel blocks, each pixel block having a pixel transistor and a capacitor corresponding thereto, so as to drive the corresponding pixel transistor and capacitor according to a display pixel signal and a display driving signal thereby performing a display operation; and
a second polarizer layer disposed at one side of the second substrate opposite to the other side of the second substrate facing the display material layer.

7. The high-sensitivity mutual-capacitance in-cell touch display panel device as claimed in claim 6, wherein the plurality of opaque lines is disposed at positions corresponding to those of the K gate lines and L source lines.

8. The high-sensitivity mutual-capacitance in-cell touch display panel device as claimed in claim 7, wherein each receiving sensing electrode formed by metal mesh is a polygon, circle, ellipse, star, wedge shape, radiation shape, triangle, pentagon, hexagon, octagon, rectangle, or square.

9. The high-sensitivity mutual-capacitance in-cell touch display panel device as claimed in claim 8, wherein each receiving sensing electrode formed by metal mesh is made of material selected from the group consisting of chromium, barium, molybdenum, aluminum, silver, copper, titanium, nickel, tantalum, cobalt, tungsten, magnesium, calcium, potassium, lithium, indium, an alloy thereof, fluorine lithium, magnesium fluoride, and lithium oxide.

10. The high-sensitivity mutual-capacitance in-cell touch display panel device as claimed in claim 9, wherein the plurality of sensing electrodes is disposed at one side of the black matrix layer facing the display material layer.

11. The high-sensitivity mutual-capacitance in-cell touch display panel device as claimed in claim 9, wherein the plurality of sensing electrodes is disposed in the thin film transistor layer.

12. A high-sensitivity mutual-capacitance in-cell touch display panel device, comprising:
a first substrate;
a second substrate parallel to the first substrate;
a display material layer configured between the first substrate and the second substrate;
a cathode layer disposed at one side of the first substrate facing the display material;
a plurality of receiving sensing electrodes disposed between the first substrate and the second substrate;
a display control circuit for controlling the high-sensitivity mutual-capacitance in-cell touch display panel device to display image, wherein the display control circuit is powered by a first power source and is connected to a first ground;
a touch sensing control circuit coupled to the plurality of receiving sensing electrodes for receiving a touch sensing signal sensed by each receiving sensing electrode, wherein the touch sensing control circuit is powered by a second power source and is connected to a second ground; and
a touch signal driving circuit connected to the touch sensing control circuit and the cathode layer,
wherein the first power source and the first ground are different from the second power source and the second ground and, in touch sensing detection, the touch sensing control circuit applies a touch signal to the touch signal driving circuit to generate a transmitting signal for being applied to the cathode layer, and the plurality of receiving sensing electrodes receives the touch sensing signals.

13. The high-sensitivity mutual-capacitance in-cell touch display panel device as claimed in claim 12, further comprising:
a thin film transistor layer disposed at one side of the second substrate facing the display material layer, and including K gate lines and L source lines, where K and L are each a positive integer, the K gate lines being arranged in a first direction and the L source lines being arranged in a second direction for forming a plurality of pixel blocks, each pixel block having a pixel transistor and a capacitor corresponding thereto, so as to drive the corresponding pixel transistor and capacitor according to a display pixel signal and a display driving signal thereby performing a display operation, wherein the first direction is perpendicular to the second direction.

14. The high-sensitivity mutual-capacitance in-cell touch display panel device as claimed in claim 13, further comprising:
a black matrix layer disposed at one side of the first substrate facing the display material layer, the black matrix layer being composed of a plurality of opaque lines arranged in the first direction and the second direction thereby defining a plurality of light-penetrating blocks; and
a color filter layer disposed at one side of black matrix layer facing the display material layer,
wherein the plurality of opaque lines is disposed at positions corresponding to those of the K gate lines and L source lines.

15. The high-sensitivity mutual-capacitance in-cell touch display panel device as claimed in claim 13, wherein each of the receiving sensing electrodes is a polygon, circle, ellipse, star, wedge shape, radiation shape, triangle, pentagon, hexagon, octagon, rectangle, or square.

16. The high-sensitivity mutual-capacitance in-cell touch display panel device as claimed in claim 15, wherein each of the receiving sensing electrodes is made of material selected from the group consisting of indium tin oxide, zinc tin oxide thin film, ETO, nano silver, conductive polymer, carbon nanotube, and graphene.

17. The high-sensitivity mutual-capacitance in-cell touch display panel device as claimed in claim 15, wherein each receiving sensing electrode is formed by metal mesh.

18. The high-sensitivity mutual-capacitance in-cell touch display panel device as claimed in claim 17, wherein each receiving sensing electrode formed by metal mesh is made of material selected from the group consisting of chromium, barium, molybdenum, aluminum, silver, copper, titanium, nickel, tantalum, cobalt, tungsten, magnesium, calcium, potassium, lithium, indium, an alloy thereof, fluorine lithium, magnesium fluoride, and lithium oxide.

19. The high-sensitivity mutual-capacitance in-cell touch display panel device as claimed in claim 18, wherein the plurality of receiving sensing electrodes is disposed at one side of the black matrix layer facing the display material layer.

20. The high-sensitivity mutual-capacitance in-cell touch display panel device as claimed in claim 18, wherein the plurality of receiving sensing electrodes is disposed in the thin film transistor layer.

21. A high-sensitivity mutual-capacitance in-cell touch display panel device, comprising:
a first substrate;
a second substrate parallel to the first substrate;
a display material layer configured between the first substrate and the second substrate;
an anode layer disposed at one side of the first substrate facing the display material layer;
a plurality of receiving sensing electrodes disposed between the first substrate and the second substrate;
a display control circuit for controlling the high-sensitivity mutual-capacitance in-cell touch display panel device to display image, wherein the display control circuit is powered by a first power source and is connected to a first ground;
a touch sensing control circuit coupled to the plurality of receiving sensing electrodes for receiving a touch sensing signal sensed by each receiving sensing electrode, wherein the touch sensing control circuit is powered by a second power source and is connected to a second ground; and
a touch signal driving circuit connected to the touch sensing control circuit and the anode layer,
wherein the first power source and the first ground are different from the second power source and the second ground and, in touch sensing detection, the touch sensing control circuit applies a touch signal to the touch signal driving circuit to generate a transmitting signal for being applied to the anode layer, and the plurality of receiving sensing electrodes receives the touch sensing signals.

22. The high-sensitivity mutual-capacitance in-cell touch display panel device as claimed in claim 21, further comprising:
a thin film transistor layer disposed at one side of the second substrate facing the display material layer, and including K gate lines and L source lines, where K and L are each a positive integer, the K gate lines being arranged in a first direction and the L source lines being arranged in a second direction for forming a plurality of pixel blocks, each pixel block having a pixel transistor and a capacitor corresponding thereto, so as to drive the corresponding pixel transistor and capacitor according to a display pixel signal and a display driving signal thereby performing a display operation, wherein the first direction is perpendicular to the second direction.

23. The high-sensitivity mutual-capacitance in-cell touch display panel device as claimed in claim 22, further comprising:
a black matrix layer disposed at one side of the first substrate facing the display material layer, the black matrix layer being composed of a plurality of opaque lines arranged in the first direction and the second direction thereby defining a plurality of light-penetrating blocks; and
a color filter layer disposed at one side of black matrix layer facing the display material layer,
wherein the plurality of opaque lines is disposed at positions corresponding to those of the K gate lines and L source lines.

24. The high-sensitivity mutual-capacitance in-cell touch display panel device as claimed in claim 22, wherein each of the receiving sensing electrodes is a polygon, circle, ellipse, star, wedge shape, radiation shape, triangle, pentagon, hexagon, octagon, rectangle, or square.

25. The high-sensitivity mutual-capacitance in-cell touch display panel device as claimed in claim 24, wherein each of the receiving sensing electrodes is made of material selected from the group consisting of indium tin oxide, zinc tin oxide thin film, ETO, nano silver, conductive polymer, carbon nanotube, and graphene.

26. The high-sensitivity mutual-capacitance in-cell touch display panel device as claimed in claim 24, wherein each receiving sensing electrode is formed by metal mesh.

27. The high-sensitivity mutual-capacitance in-cell touch display panel device as claimed in claim 26, wherein each receiving sensing electrode formed by metal mesh is made of material selected from the group consisting of chromium, barium, molybdenum, aluminum, silver, copper, titanium, nickel, tantalum, cobalt, tungsten, magnesium, calcium, potassium, lithium, indium, an alloy thereof, fluorine lithium, magnesium fluoride, and lithium oxide.

28. The high-sensitivity mutual-capacitance in-cell touch display panel device as claimed in claim 27, wherein the plurality of receiving sensing electrodes is disposed at one side of the black matrix layer facing the display material layer.

29. The high-sensitivity mutual-capacitance in-cell touch display panel device as claimed in claim 27, wherein the plurality of receiving sensing electrodes is disposed in the thin film transistor layer.
